(19) United States
(12) Patent Application Publication
(10) Pub. No.: US 2010/0261027 A1
(43) Pub. Date: Oct. 14, 2010

(54) PAPER COATING COMPOSITIONS

(75) Inventors: Maria Gabriella COCCIA, Bergamo (IT); Massimo MAGNONI, Bergamo (IT); Paolo ALIOLI, Bergamo (IT)

Correspondence Address: LUCAS & MERCANTI, LLP, 475 PARK AVENUE SOUTH, 15TH FLOOR, NEW YORK, NY, 10016, US

(73) Assignee: 3V SIGMA S.P.A, Milano (IT)

(21) Appl. No.: 12/719,608

(22) Filed: Mar. 8, 2010

(30) Foreign Application Priority Data
Apr. 10, 2009 (IT) MI2009A 000598

(51) Int. Cl. B32B 29/00; C09K 11/06

(52) U.S. Cl. 428/537.7; 428/537.5; 252/301.23

(57) ABSTRACT

The present invention relates to a coating composition for paper and cardboard comprising at least one white pigment, at least one polymeric ligand and at least one synthetic or natural co-ligand, and a mixture of optical whiteners.

### CROSS-REFERENCE TO RELATED APPLICATION

This application claims the benefit of priority from Italian Patent Application No. MI2009A 000598, filed Apr. 10, 2009, the contents of which are incorporated herein by reference.

### FIELD OF THE INVENTION

The present invention relates to a composition for manufacturing coated paper and cardboard having a high degree of whiteness by using optical whiteners.

### BACKGROUND OF THE INVENTION

It is known that paper coating consists in the application of one or more uniform layers of specific compositions, known as patinas, which are useful for leveling and smoothing the paper or cardboard surface in order to adjust its ink receptivity in the print phase and to improve its optical properties (whiteness degree, gloss, etc). It is customary to add the composition with optical whiteners in order to confer the treated paper a high whiteness degree. The obtainable whiteness degree depends, in addition to the general composition of the mixture, on the type of the used optical whitener.

### SUMMARY OF THE INVENTION

WO2004/005617 discloses a fluorescent whitening agent comprising a mixture of two symmetrically and one asymmetrically substituted triazinylaminostilbene disulphonic acids, novel asymmetrically substituted derivatives, a process for their preparations and use of the mixture for whitening synthetic or natural organic materials, especially paper and for the fluorescent whitening and improvement of sun protection factors for textile materials.

WO2004/046293 discloses bis-triazinylaminostilbene fluorescent whitening agents, comprising both individual components and mixtures thereof, a process for their preparation, intermediates useful for their preparation and use of the fluorescent whitening agents for the fluorescent whitening of paper.

WO2002/055646 discloses an optical brightener mixture comprising triazinylaminostilbene disulphonic acids, their concentrated aqueous solution, their production and their use.

However, none of the above mentioned documents disclose a mixture comprising both tetrasulphonated and hexasulphonated triazinylaminostilbene compounds.

Among the most common optical whiteners used in the paper composition there are for example those mentioned in the European patent EP1355004, represented by the following general formula:

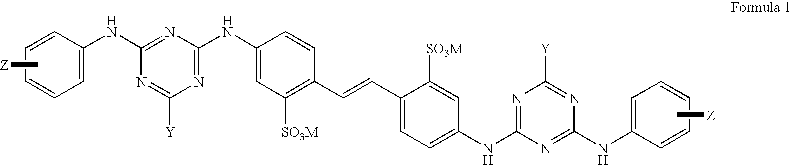

wherein:

Z=SO₃M

M=H, Na, K

Y=N(CH₂CH₂OH)₂, N[CH₂CH(CH₃)OH]₂

The number of the Z substituents for each aromatic ring can be 0, 1 or 2, thus giving place to the optical whiteners which are commonly denominated “disulphonated”, tetrasulphonated”, “hexasulphonated”.

Optical whiteners having the following general formula are also known:

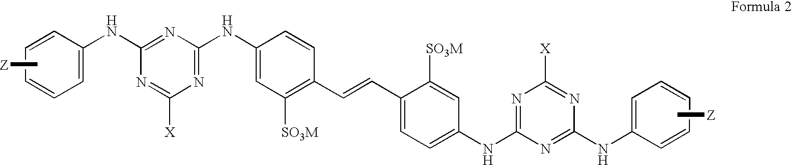

wherein: Formula 2

Z=SO₃M and M=H, Na, K, NH₄

X=N(CHRCH₂R₁) with R=H, C₁-C₆ Alkyl; R₁=H, C₁-C₆ Alkyl

These compounds, like all known optical whiteners, are characterized by a “plateau” behaviour, meaning that by increasing their concentration in the selected composition, the obtainable whiteness degree on the treated paper increases at first very quickly, and then more and more slowly until a saturation maximum value is reached which is followed, in case that the concentration of the optical whitener is further increased, by a decrease of the whiteness degree which is known as “graying” or “greening”, and corresponds to an accumulation of the optical whitener in the treated paper. The saturation limit and the subsequent accumulation of the whitener can be followed with suitable measurements, by means of the use of a reflectometer, of the three colorimetric coordinates of the CIE-LAB system.

The maximum obtainable whiteness grade before the graying phenomenon is, therefore, also strictly connected to the type of optical whitener that is used. The higher the concentration of whitener at the saturation limit, the higher the whiteness grade that may be obtained.

The concentration of whitener corresponding to the saturation limit varies according to the obtainable whiteness grade.

The applicant has now surprisingly found that it is possible to obtain paper characterized by a high degree of whiteness by using a coating composition comprising a mixture of a particular optical whitener having formula 2 and a particular optical whitener having formula 1. In particular it has been found that, by suitably selecting some compounds among the above mentioned general formulas, the resulting composition allows to obtain, before reaching the graying point, a degree of whiteness which is higher than that obtainable by using separately the whiteners of formula 1 and 2.

### BRIEF DESCRIPTION OF THE DRAWINGS

Further advantages and features of the according to the present invention will become clear to those skilled in the art from the following detailed and non-limiting description of some embodiments thereof with reference to the attached drawings, wherein:

FIG. 1 is a graphic showing the colorimetric coordinates of the samples obtained according to example 7;

FIG. 2 is a graphic showing the colorimetric coordinates of the samples obtained according to example 8; and

FIG. 3 is a graphic showing the colorimetric coordinates of the samples obtained in conformity to example 9.

### DETAILED DESCRIPTION OF THE INVENTION

The invention particularly relates to a composition comprising a mixture of at least one tetrasulphonated optical whitener of formula 2, that is bearing one substituent Z on the aromatic ring, and at least one hexasulphonated optical whitener of formula 1, that is selected among those bearing two Z groups for each aromatic ring.

The quantity of the hexasulphonated optical whitener of formula 1 is preferably included between 5% and 40% by weight of the mixture of the two whiteners. More preferably, the optical whitener of formula 1 is present in a quantity between 15% and 25% of the total weight of the mixture.

Particularly preferred according to the present invention is a composition comprising an optical whitener of formula 2a:

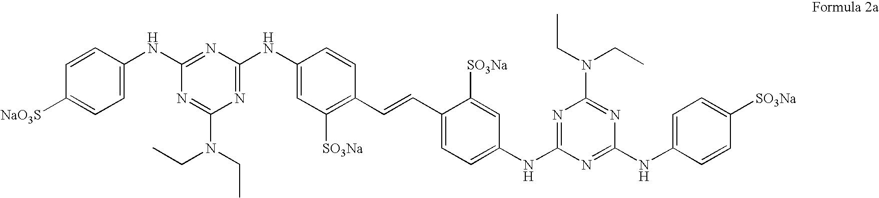

wherein the group Z, with M=Na, is in para position with respect to the group —NH—, and wherein the triazine ring substituent X is N(CHRCH₂R₁) with R=R₁=H.

As far as the optical whiteners of formula 1 are concerned, particularly preferred are the compositions comprising compounds of formula 1a:

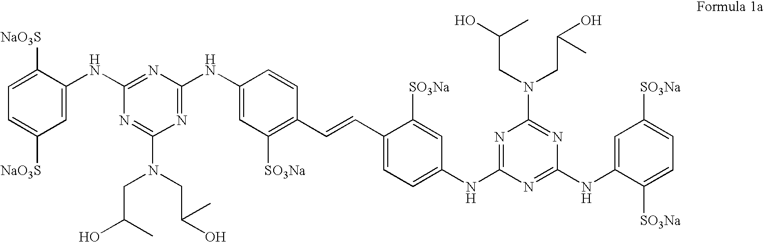

wherein the two Z groups, with M=Na, are in position 2 and 5 with respect to the group —NH— and Y=N[CH₂CH(CH₃)OH]₂.

The compositions according to the invention, besides the optical whiteners mixture, contain at least one white pigment, at least one polymeric ligand and at least one synthetic or natural coligand.

The white pigment of the invention can be for example calcium carbonate, kaolin, talc, titanium dioxide, barium sulfate, aluminum hydroxide, satin white or mixtures thereof.

The polymeric ligand is a substance that, by coating the pigment particles, joins them together, fixing them to the support; it also keeps the pigment in suspension. All the polymeric ligands normally used in the preparations of paper coating compositions can be used in the compositions according to the invention. Examples thereof are in the form of polymeric latex, such as styrene/butadiene and/or styrene/acrylate copolymer, vinyl acetate, possibly modified with the introduction of a third monomer such as acrylonitrile, acrylamide, acrylic acid, methacrylic acid, maleic acid, itaconic acid, vinyl chloride, vinyl esters, ethylene, or mixtures thereof. Also, natural coligands may be present, in form of powder or water dispersions such as casein, starch, amylose, amylopectin, possibly a mixture thereof or synthetic coligands such as carboxymethyl cellulose, hydroxyalkyl cellulose, polyvinyl alcohol and acrylic type rheology modifiers or mixtures thereof.

The quantity of white pigments of the compositions is generally comprised between 70% and 90% by weight, calculated with respect to the dry content of the composition.

The quantity of the previously mentioned ligands and coligand which can be present in the compositions of the invention are comprised between 2 and 20% by weight, calculated with respect to the dry content of the composition.

Besides, the mixtures of optical whiteners of the invention may contain as optional ingredients: stabilizing agents such as urea, propylene glycol, glycerol; carriers such as polyglycols, polyvinylalcohols, natural and modified starches, disperdants, preservatives, sequestering agent, antifoam, pH correctors, etc.

The mixture of whiteners 1 and 2 can be used, for the preparation of the compositions according to the invention, both in water solution and in powder. In the case that it is used as a powder, it is certainly preferable to form a solution before preparing the compositions according to the present invention.

The mixture of optical whiteners can also be directly obtained in the coating composition, by adding to the same separately the optical whiteners of formula 1 and 2. In other words, the optical whiteners 1 and 2 need not to be premixed before being incorporated into the composition according to the present invention.

The water solutions of the mixture of whiteners according to the invention preferably contain:

1) 10% to 30% by weight of the mixture of optical whiteners;

2) 0% to 5% by weight of inorganic salts;

3) 65% to 90% by weight of water.

The optical whiteners used according to the present invention are obtained according to known methods, as described for example in patents GB-A-896533 or in EP-A-860437. For example, said whiteners can be obtained by reaction of cyanuric chloride with 4,4′-diaminostilbene-2,2′-disulfonic acid. The obtained product is reacted with sulfanilic acid or with aniline 2,5-disulfonic acid dependent on which optical whitener, of formula 2 or of formula 1, is being prepared, and with amines corresponding to the substituents Y and X of the formulas 1 and 2. At the end of the reaction, the row solution of the optical whitener can be desalted, for example by suitable separation methods on a membrane and concentrated for example as described in patent EP-A-992547.

The preferred methods for separation on a membrane are ultrafiltration, diffusion dialysis and electrodyalisis. However, it is also possible to isolate the resulting optical whitener as a solid, for example through salting or addition of an acid. The formed solid may be isolated, for example on a filter press and further purified by washing.

Water solutions can also be prepared from raw solutions, and from concentrated and desalted solutions. In order to obtain a particularly functional solution it is advantageous, if desired, to incorporate a carrier substance in the water solutions.

The concentrations of the solutions of the optical whiteners are generally characterized by the parameter E^{1%}_{1cm}, corresponding to the extinction value at the wave length of maximum absorbance of a solution containing 1% of the considered product, measured with an optical path of 1 cm. The values of E¹₁ of the solutions of optical whiteners of the invention are preferably included between 50 and 180 and more preferably between 90 and 140.

The compositions according to the invention can be applied on the paper one or more times by using any method suitable for this purpose, such as metal blade coating, leveling rolls coating, brush coating, air-blade coating, knife coating, compression coating, etc.

The subsequent immobilization and drying of the coating can be carried out first with hot water and/or IR radiation and/or with steam heated drying cylinders, and following with hot calendering.

The compositions according to the invention may be applied on any paper support. The invention is better illustrated by the following examples.

### Example 1

### Preparation of a Water Solution of the Whitener (2a) without Carrier

82.9 g of a water solution of the optical whitener of formula (2a), concentrated by filtration on an osmotic membrane and having a E¹₁ value of 155 and a pH value of 9, were mixed with 19.9 g of demineralized water under stirring at room temperature. 102.8 g of a dark yellow homogeneous solution without carrier with a value of E¹₁ of 125 were obtained, corresponding to a (2a) content of about 22% by weight.

### Example 2

### Preparation of a Mixture of Whiteners of Formula (1a) and (2a) without Carrier

75.7 g of a water solution of the optical whitener of formula (2a), concentrated by filtration on an osmotic membrane and having a E¹₁ value of 155 and a pH value of 9, were mixed with 10 g of a water solution of the optical whitener of formula (1a) concentrated by filtration on an osmotic membrane and having a E¹₁ value of 125 and a pH value of 9, and with 14.3 g of demineralized water under stirring at room temperature. 100 g of a dark yellow homogeneous solution without carrier with a value of E¹₁ of 125 were obtained, corresponding to a (2a)+(1a) content of about 22.5% by weight.

### Example 3

### Preparation of a Mixture of Whiteners of Formula (1a) and (2a) without Carrier

64.6 g of a water solution of the optical whitener of formula (2a), concentrated by filtration on an osmotic membrane and having a E¹₁ value of 155 and a pH value of 9, were mixed with 20 g of a water solution of the optical whitener of formula (1a) concentrated by filtration on an osmotic membrane and having a E¹₁ value of 125 and a pH value of 9, and with 14.3 g of demineralized water under stirring at room temperature. 100 g of a dark yellow homogeneous solution without carrier with a value of E¹₁ of 125 were obtained, corresponding to a (2a)+(1a) content of about 23% by weight.

### Example 4

### Preparation of a Mixture of Whiteners of Formula (1a) and (2a) with Carrier

61.0 g of a water solution of the optical whitener of formula (2a), concentrated by filtration on an osmotic membrane and having a E¹₁ value of 155 and a pH value of 9, were mixed with 8.4 g of a water solution of the optical whitener of formula (1a) concentrated by filtration on an osmotic membrane and having a E¹₁ value of 125 and a pH value of 9, and with 30 g of polyethylene glycol 1500 under stirring at room temperature. 100 g of a dark yellow homogeneous solution with 30% by weight of carrier with a value of E¹₁ of 105 were obtained. This corresponds to a content of (2a)+(1a) of about 19% by weight.

### Example 5

### Preparation of a Water Solution of the Whitener According to the Prior Art without Carrier

77.5 g of a water solution, concentrated by filtration on an osmotic membrane and having a E¹₁ value of 161 and a pH value of 8.5, containing the optical whitener of formula (3), which corresponds to the optical whitener of formula 1 wherein

Z=SO₃M with M=Na

Y=N[CH₂CH(CH₃)OH]₂

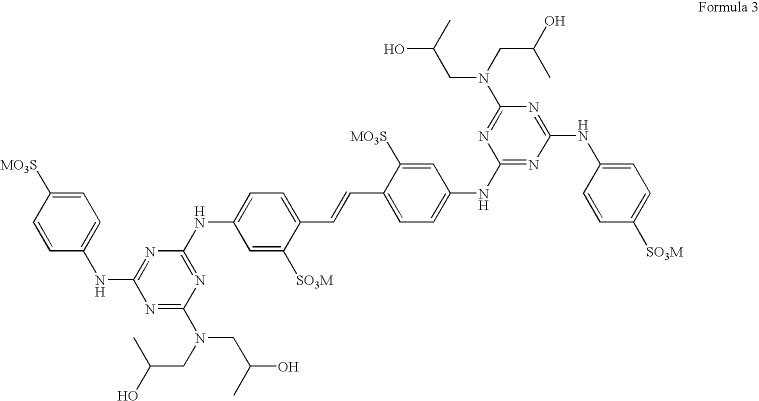

in form of a sodium salt, were mixed with 22 g of demineralized water under stirring and then a 10% solution of caustic soda in quantity such as to regulate the pH at 9.0. Thus, a dark yellow homogeneous solution without carrier with a value of E¹₁ of 125 was obtained. This corresponding to a formula (3) whitener content of about 23% by weight.

### Example 6

### Preparation of a Water Solution of Whitener According to the Prior Art with Carrier

65.2 g of a water solution, concentrated by filtration on an osmotic membrane and having a E¹₁ value of 161 and a pH value of 8.5, containing the optical whitener having the above shown formula (3) in form of sodium salt, were mixed with 31 g of polyethylene glycol 1500 (average molar mass Mn of 1550 g/mol) under stirring at room temperature. Due to the waxy consistency at room temperature of polyethylene glycol 1500, it was heated at a temperature of about 60° C. in order to obtain a liquid and it was processed still hot. Further, 3.5 g of demineralized water and a 10% solution of caustic soda in quantity such as to regulate the pH at 9.0 were added. The preparation was then heated at 50° C. under stirring and mixed for 30 minutes at this temperature. After cooling at room temperature a fluorescent homogeneous dark yellow solution was obtained, with carrier and with a value E¹₁ of 105. This corresponds to a content of (3) of about 19% by weight.

In the tests reported in the following examples, the support paper was type “Fabriano 2 smooth” having density of 110 g/m².

All the coated test specimens were obtained by applying, by means of a lab knife, a uniform layer of composition corresponding to 25 g/m² additioned with different parts of the optical whiteners to be tested.

The quantities of optical whitener, expressed as a weight percentage, are referred to the dry solid content of the composition.

At the end of the application the test specimens were dried at room temperature for one hour.

The white values were measured by an ELREPHO reflectometer LWE450-X (Data Color).

### Example 7

A composition was prepared according to the following procedure:
100 parts of natural pigment (80 parts of calcium carbonate Hydrocarb 90AV and 20 parts of kaolin Hydrafine)
12 parts of synthetic ligand BASF Stironal D517 (styrene/butadiene)
0.5 parts of coligand (carboxymethyl cellulose Finnix 10)
Sodium hydroxide in solution (NaOH 10%) to pH 9
water until final dry content is 65%

and it was divided into 19 parts, of which one was left unchanged; six were additioned with a whitener 3 solution prepared in example 5, in different weight percent quantities, i.e. 0.4-0.8-1.2-1.6-2.0-2.4%.

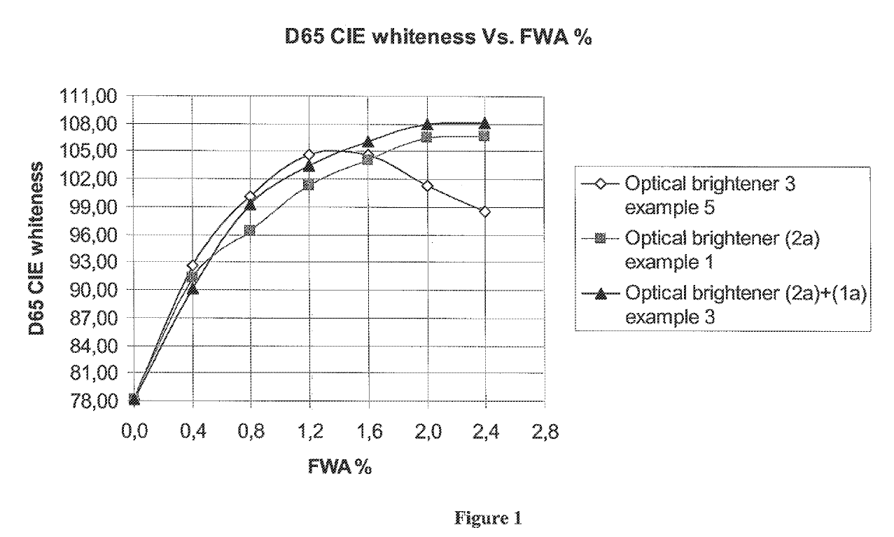

Six other parts were additioned with a whitener (2a) solution prepared in example 1, and the remaining six with a solution of whitener (2a)+(1a) prepared in example 3, in the same weight percent quantities as above indicated. The values obtained in the measurements of the white grade of the test specimens are reported in the following table 1 and graphically shown in FIG. 1, from which it is evident that the use of the solution according to the invention allows to obtain a higher grade of white, with respect to the solutions according to the known art.

TABLE 1

| | | | | |
|---|---|---|---|---|
| dosage % | D65 CIE whiteness | L* | a* | b* |

Optical whitener 3 example 5 (E¹₁ = 125)

| | | | | |
|---|---|---|---|---|
| 0.00 | 78.20 | 96.32 | 0.20 | 2.81 |
| 0.40 | 92.55 | 96.69 | 0.4 | −0.9 |
| 0.80 | 100.20 | 96.1 | 1.3 | −1.79 |
| 1.20 | 104.70 | 97.9 | 1.5 | −2.71 |
| 1.60 | 104.59 | 97.4 | 0.6 | −2.60 |
| 2.00 | 101.33 | 97.7 | 0.5 | −1.80 |
| 2.40 | 98.53 | 97.4 | −0.0 | −1.13 |

Whitener (2a) example 1 (E¹₁ = 125)

| | | | | |
|---|---|---|---|---|
| 0.00 | 78.20 | 96.32 | 0.20 | 2.81 |
| 0.40 | 91.31 | 96.72 | 0.76 | 0.10 |
| 0.80 | 96.42 | 96.81 | 0.98 | −0.99 |
| 1.20 | 101.27 | 96.95 | 1.15 | −2.01 |
| 1.60 | 104.07 | 97.02 | 1.24 | −2.60 |
| 2.00 | 106.50 | 97.16 | 1.24 | −3.09 |
| 2.40 | 106.60 | 97.20 | 1.11 | −3.08 |

Whitener (2a) + (1a) example 3 (E¹₁ = 125)

| | | | | |
|---|---|---|---|---|
| 0.00 | 78.20 | 96.32 | 0.20 | 2.81 |
| 0.40 | 90.23 | 96.66 | 0.74 | 0.31 |
| 0.80 | 99.23 | 96.92 | 1.11 | −1.56 |
| 1.20 | 103.52 | 97.05 | 1.25 | −2.46 |
| 1.60 | 106.14 | 97.16 | 1.26 | −3.00 |
| 2.00 | 108.02 | 97.32 | 1.13 | −3.34 |
| 2.40 | 108.15 | 97.37 | 0.96 | −3.34 |

### Example 8

A composition was prepared according to the following procedure:
100 parts of natural pigment (80 parts of calcium carbonate Hydrocarb 90AV and 20 parts of kaolin Hydrafine)
10 parts of synthetic ligand BASF Acronal S728 (styrene/n-Butyl acrylate)
1.0 parts of coligand (0.5 parts of carboxymethyl cellulose Finnix 10+0.5 parts of polyvinyl alcohol Mowiol 4-98)
Sodium hydroxide in solution (NaOH 10%) to pH˜9
water until final dry content is 65%

and it was divided into 15 parts, of which one was left unchanged; seven were additioned with a whitener 3 solution prepared in example 5, in different weight percent quantities, i.e. 0.4-0.8-1.2-1.6-2.0-2.4-2.8%, and the remaining seven with a solution of whitener (2a)+(1a) prepared in example 2, in the same weight percent quantities as above indicated.

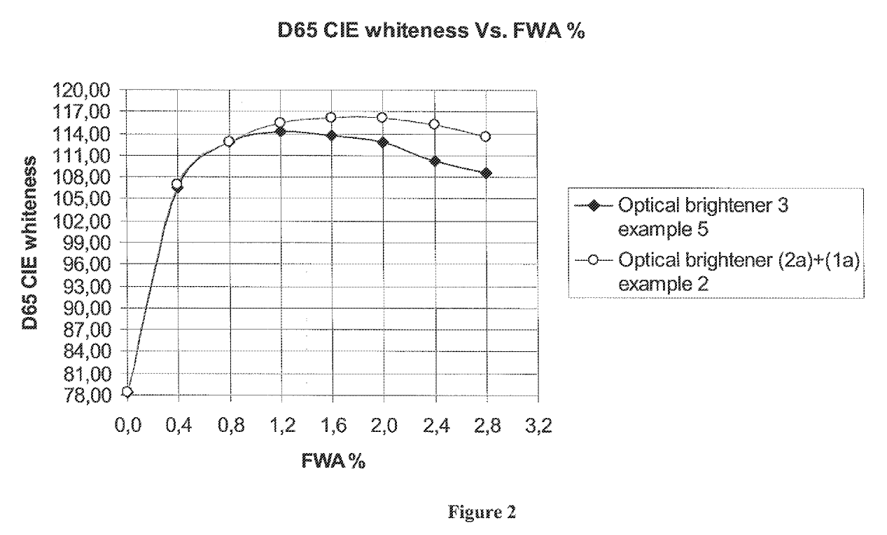

The values obtained in the measurements of the white grade of the test specimens are reported in the following table 2 and graphically shown in FIG. 2. From the figure it is evident that the solution comprising optical whitener 3 of example 5, according to the prior art, can reach a maximum white grade of 114 at the dosage of 1.20 whereas with the solution according to the invention it is possible to increase the concentration of the whiteners to reach a maximum grade of white of 116, without having the graying effect.

TABLE 2

| | | | | |
|---|---|---|---|---|
| dosage % | D65 CIE whiteness | L* | a* | b* |

Whitener 3 example 5 (E¹₁ = 125)

| | | | | |
|---|---|---|---|---|
| 0.00 | 78.38 | 96.31 | 0.21 | 2.77 |
| 0.40 | 106.60 | 96.90 | 1.96 | −3.24 |
| 0.80 | 112.80 | 97.11 | 2.14 | −4.53 |
| 1.20 | 114.36 | 97.24 | 1.97 | −4.82 |
| 1.60 | 113.71 | 97.33 | 1.63 | −4.62 |
| 2.00 | 112.88 | 97.45 | 1.27 | −4.36 |
| 2.40 | 110.25 | 97.47 | 0.81 | −3.76 |
| 2.80 | 108.61 | 97.51 | 0.51 | −3.37 |

Whitener (2a) + (1a) example 2 (E¹₁ = 125)

| | | | | |
|---|---|---|---|---|
| 0.00 | 78.38 | 96.31 | 0.21 | 2.77 |
| 0.40 | 107.01 | 96.90 | 1.96 | −3.33 |
| 0.80 | 112.90 | 97.06 | 2.18 | −4.58 |
| 1.20 | 115.42 | 97.22 | 2.11 | −5.07 |
| 1.60 | 116.21 | 97.30 | 1.99 | −5.21 |
| 2.00 | 116.12 | 97.40 | 1.77 | −5.14 |
| 2.40 | 115.27 | 97.48 | 1.47 | −4.90 |
| 2.80 | 113.54 | 97.53 | 1.11 | −4.48 |

### Example 9

A composition having a low coligand content, prepared according to the following procedure:
100 parts of natural pigment (80 parts of calcium carbonate Hydrocarb 90AV and 20 parts of kaolin Hydrafine)
12 parts of synthetic ligand BASF Stironal D517 (styrene/butadiene)
0.2 parts of coligand (carboxymethyl cellulose Finnix 10)
Sodium hydroxide in solution (NaOH 10%) to pH˜9
water until final dry content is 65%

was divided into 17 parts, of which one was left unchanged; eight were additioned with 0.5-1.0-1.5-2.0-2.5-3.0-3.5-4.0% of a whitener 3 solution prepared in example 6, in different weight percent quantities, and the remaining eight with a solution of whitener (2a)+(1a) prepared in example 4, in the same weight percent quantities as above indicated.

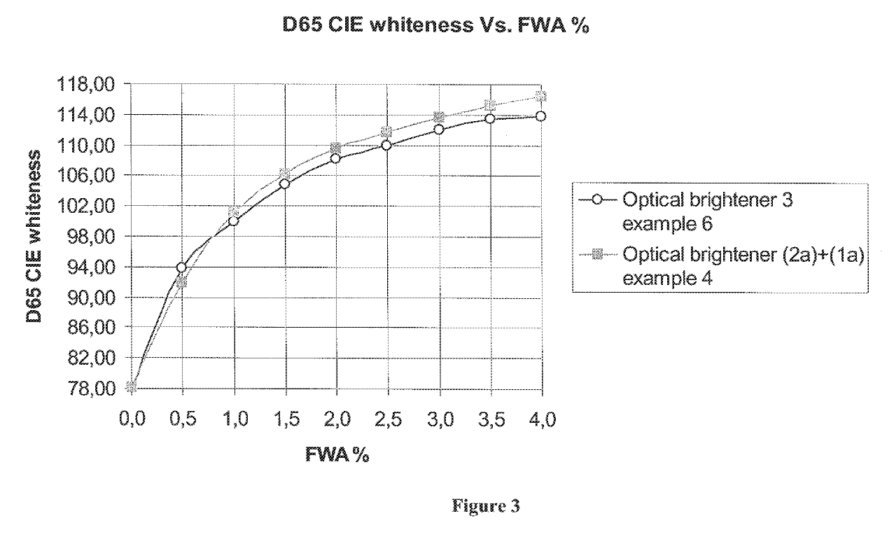

The obtained values are reported in the following table 3 and graphically shown in FIG. 3. From FIG. 3 it is evident that the solution comprising optical whitener 3 with carrier obtained in example 6, according to the prior art, can reach at the percent dosage of 4.0 a maximum white grade lower than 114, whereas with the solution comprising a carrier according to the invention it is possible to reach a maximum grade of white of more than 116.

TABLE 3

| | | | | |
|---|---|---|---|---|
| dosage % | D65 CIE whiteness | L* | a* | b* |

Optical whitener 3 example 6 (E¹₁ = 105)

| | | | | |
|---|---|---|---|---|
| 0.00 | 78.25 | 96.34 | 0.19 | 2.81 |
| 0.50 | 93.75 | 96.78 | 0.83 | −0.41 |
| 1.00 | 100.00 | 96.97 | 1.04 | −1.71 |
| 1.50 | 104.90 | 97.12 | 1.30 | −2.74 |
| 2.00 | 108.09 | 97.18 | 1.51 | −3.43 |
| 2.50 | 109.96 | 97.16 | 1.64 | −3.86 |
| 3.00 | 111.99 | 97.25 | 1.72 | −4.28 |
| 3.50 | 113.37 | 97.27 | 1.77 | −4.58 |
| 4.00 | 113.87 | 97.25 | 1.80 | −4.70 |

Whitener (2a) + (1a) example 4 (E¹₁ = 105)

| | | | | |
|---|---|---|---|---|
| 0.00 | 78.25 | 96.34 | 0.19 | 2.81 |
| 0.50 | 91.88 | 96.71 | 0.83 | −0.03 |
| 1.00 | 101.09 | 96.96 | 1.27 | −1.96 |
| 1.50 | 106.19 | 97.06 | 1.56 | −3.06 |
| 2.00 | 109.59 | 97.16 | 1.73 | −3.78 |
| 2.50 | 111.72 | 97.20 | 1.85 | −4.24 |
| 3.00 | 113.57 | 97.24 | 1.93 | −4.64 |
| 3.50 | 115.25 | 97.28 | 1.99 | −5.00 |
| 4.00 | 116.44 | 97.30 | 2.03 | −5.26 |

1. Coating composition for paper and cardboard comprising at least one white pigment, at least one polymeric binder and at least one natural or synthetic co-binder, and a mixture containing:
at least one optical brightener of formula (1) 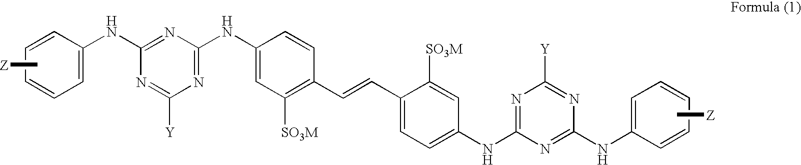
wherein in formula (1) the number of the Z substituents, for each aromatic ring, equals 2 and at least one optical brightener of formula (2) 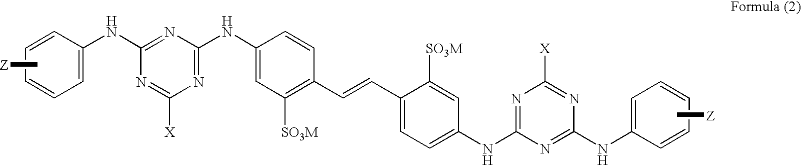
wherein in formula (2) the number of the Z substituents, for each aromatic ring, equals 1
and wherein:
Z=SO₃M
M=H, Na, K, NH₄ or an organic ammonium radical
Y=N(CH₂CH₂OH)₂, N[CH₂CH(CH₃)OH]₂
X=N(CHRCH₂R₁) wherein R=H or C₁-C₆ alkyl; R₁=H or C₁-C₆ alkyl.

2. Composition according to claim 1, wherein said mixture comprises said optical brightener of formula (1) in a weight percentage of 5% to 40% with respect to the mixture and said optical brightener of formula (2) in a weight percentage of 60% to 95% with respect to the mixture.

3. Composition according to claim 2, wherein the mixture comprises 15% to 25% by weight of the optical brightener of formula (1) and 75% to 85% by weight of the optical brightener of formula (2).

4. Composition according to claim 1 wherein the optical brightener of formula (1) is

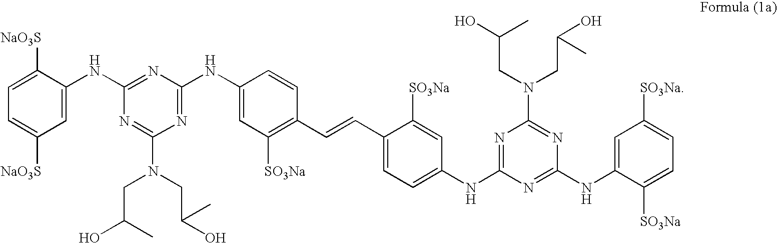

5. Composition according to claim 1 wherein the optical brightener of formula (2) is

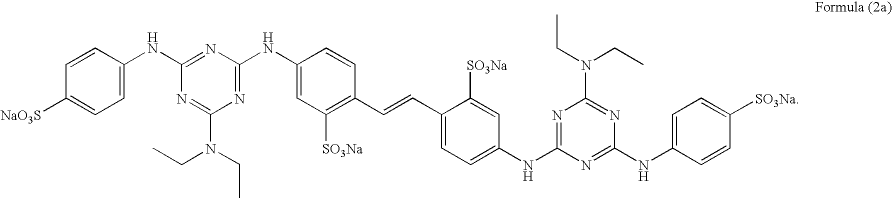

6. Composition according to claim 1, wherein said mixture of optical whiteners comprises at least one carrier compound.

7. Method for coating paper or paperboard characterized in that a composition according to claim 1 is used.

8. Method according to claim 7, wherein the optical brighteners of formulas (1) and (2) are incorporated directly in the composition.

9. Paper or cardboard coated with a composition according to claim 1.
